(19) United States
(12) Patent Application Publication
(10) Pub. No.: US 2007/0248259 A1
(43) Pub. Date: Oct. 25, 2007

(54) Apparatus for reconstructing multi-dimensional image data and a method thereof

(76) Inventor: Cheng-Wen Liu, Fengyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/408,037

(22) Filed: Apr. 21, 2006

(51) Int. Cl. G06K 9/00

(52) U.S. Cl. 382/154

(57) ABSTRACT

An apparatus for reconstructing multi-dimensional image data is used for generating a three-dimensional image of an object. An image block-rearranging unit is used for reconstructing the sub-blocks according to a plurality of two-dimensional images. A storage unit is used for storing the sub-blocks and the two-dimensional images. Next, an image-reconstructing unit reads the data of the sub-blocks from the storage unit to reconstruct the three-dimensional image of the object. When the three-dimensional image of the object is reconstructed, the data hit rate is increased so as to enhance the reconstruction speed of the three-dimensional image.

### BACKGROUND OF THE INVENTION

1. Field of the Invention

The present invention relates to an apparatus for reconstructing image data and a method thereof. In particular, this invention relates to an apparatus for reconstructing multi-dimensional image data and a method thereof.

2. Description of the Related Art

Since image process technology has been developed, it has been widely applied to the fields of medical diagnosis and medical analysis. Medical digital images have demonstrated its excellent capability of aiding medical professionals in their search for cures to patient's ailments.

Due to the limitations of computer technology, early medical facilities only displayed two-dimensional images. Therefore, a real outform or appearance of the object could not be displayed vividly. Nowadays, however, computers can process images for an object via a three-dimensional reconstruction method. As such, the shape of an object can be displayed vividly. For processing medical images, a medical instrument scans the object so as to obtain the medical digital images (such as computed tomography images, magnetic resonance images, or ultrasound images). Then, a series of images obtained from the computed tomography, the magnetic resonance images or the ultrasound images are stacked and processed via a computer so that a reconstructed three-dimensional image of the object can be displayed on a monitor device.

For the volume rendering method, the images are stacked in order according to the sequence of cutting planes to form a stack of the three-dimensional data images. Then, the computer simulates the light to traverse and to penetrate the object so as to finally project the result onto a view plane. In order to reconstruct the three-dimensional image vividly, the transparent rate, brightness and density of volume pixels in the object should be tuned by trial-and-error and set in advance. Next, a ray-casting method or a voxel-projection method is used to simulate light to pass through the volume pixels. The simulated light passing through volume pixels of the object uses a mathematical composition model so as to generate a projected image finally. A three-dimensional image is thereby displayed. Because the volume data generated from the image-forming system is complete, the identification and decision of the medical diagnosis can be made easily.

Reference is made to FIG. 1. A three-dimensional image is reconstructed via a volume rendering method. The three-dimensional image 9 is formed by stacking a plurality of two-dimensional images, which can be CT images, MRI images or ultrasound images (not shown in the figure). However, arrangement of voxels of the three-dimensional image data is denoted by many images 91 in two dimensions, and each of the images 91 is composed of 16 volume pixels 911 in this figure for illustration. However, in practice, there may be 256×256 or 512×512 pixels in each image. The three-dimensional image 9 is reconstructed according to the order of the two-dimensional images 91. The two-dimensional image 91 is reconstructed according to the order of the volume pixels 911. Finally, the three-dimensional image 9 is fully formed.

The three-dimensional reconstructing image using the volume rendering method can directly displays the image through the volume data. When the volume data of the object is particularly large, the loading of calculation loading in a computer increases dramatically so as to make the system operate slower. Therefore, the system cannot display images instantly nor respond rapidly to a user's instructions.

### SUMMARY OF THE INVENTION

One particular aspect of the present invention is to provide an apparatus for reconstructing multi-dimensional image data and a method thereof. When the multi-dimensional image data is in reconstruction, a block in a image is used as a unit to increase the hit rate of reading data in a cache/caches in the computer. Therefore, the reconstruction speed of the multi-dimensional image data is greatly improved.

An apparatus for reconstructing multi-dimensional image data is used for generating the three-dimensional image of an object. The apparatus for reconstructing multi-dimensional image data includes an image block-rearranging unit, a storage unit, and an image-reconstructing unit. The image block-rearranging unit reconstructs a plurality of sub-blocks for the object according to at least one two-dimensional image data. The sub-blocks each have a basic length in each dimension and are stored in the storage unit. The storage unit is also used for storing the two-dimensional image data. The image-reconstructing unit reads those sub-blocks from the storage unit to rebuild the three-dimensional image of the object.

A method for reconstructing multi-dimensional image data builds the three-dimensional image of an object and stores the plurality of two-dimensional images needed for the three-dimensional image of the object in a storage unit. The method includes reconstructing a plurality of sub-blocks for reconstructing the object according to the two-dimensional image data. The sub-blocks each have a basic length in each dimension. Then, the three-dimensional image of the object is reconstructed by reading the sub-blocks.

The present invention uses a sub-block as an unit to reconstruct an image data of the object and rearranges the order of the sub-block to improve the average time of accessing the voxels. Thereby, when the three-dimensional image of the object is reconstructed, the hit rate of reading the data from the cache was greatly improved so as to speed up the three-dimensional image reconstruction.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the volume data arranged logically of the prior art;

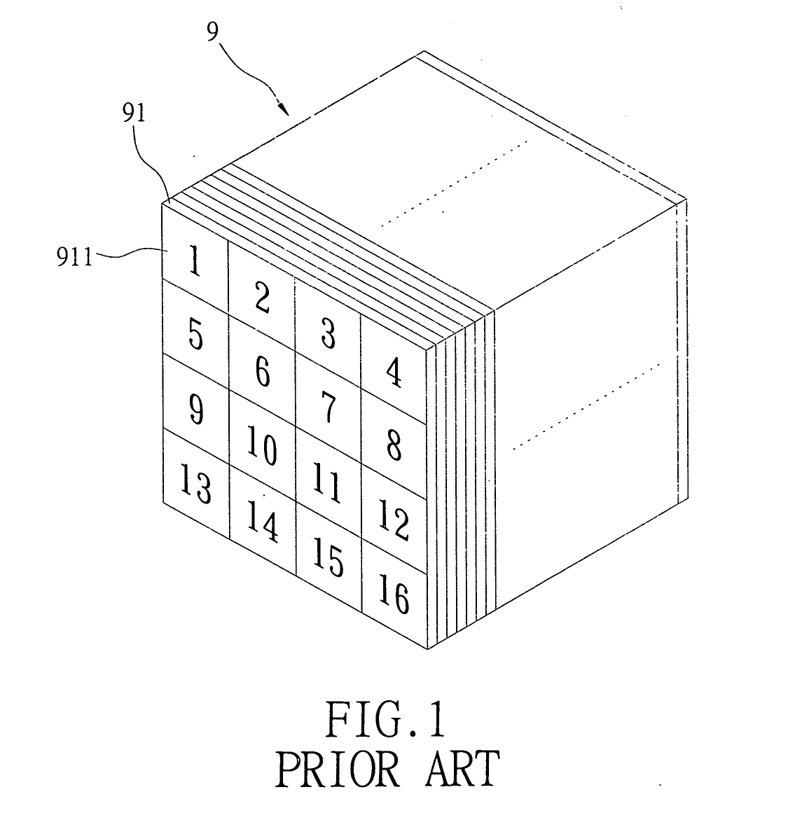

FIG. 2A is a schematic diagram of one embodiment of reconstructing a three-dimensional image via symmetric blocks of the present invention;

FIG. 2B is a schematic diagram of the sub-block arranged in a 4×4×4 volume pixel order according to the present invention;

FIG. 3A is a schematic diagram of one embodiment of reconstructing a three-dimensional image via asymmetric blocks according to the present invention;

FIG. 3B is a schematic diagram of the sub-block arranged in a 2×4×8 volume pixel order according to the present invention;

FIG. 4 is a block diagram of the preferred embodiment of the present invention; and

FIG. 5 is a flow chart of the preferred embodiment of the present invention.

### DETAILED DESCRIPTION OF THE PREFERRED EMBODIMENTS

The present invention provides an apparatus for reconstructing three-dimensional image data and a method thereof. The present invention rearranges a plurality of two-dimensional image data that forms a three-dimensional image of an object. The rearrangement of the image data is implemented by using the structure of the image block. The image block includes a plurality of volume pixels. The image is reconstructed according to the order of the rearranged image blocks.

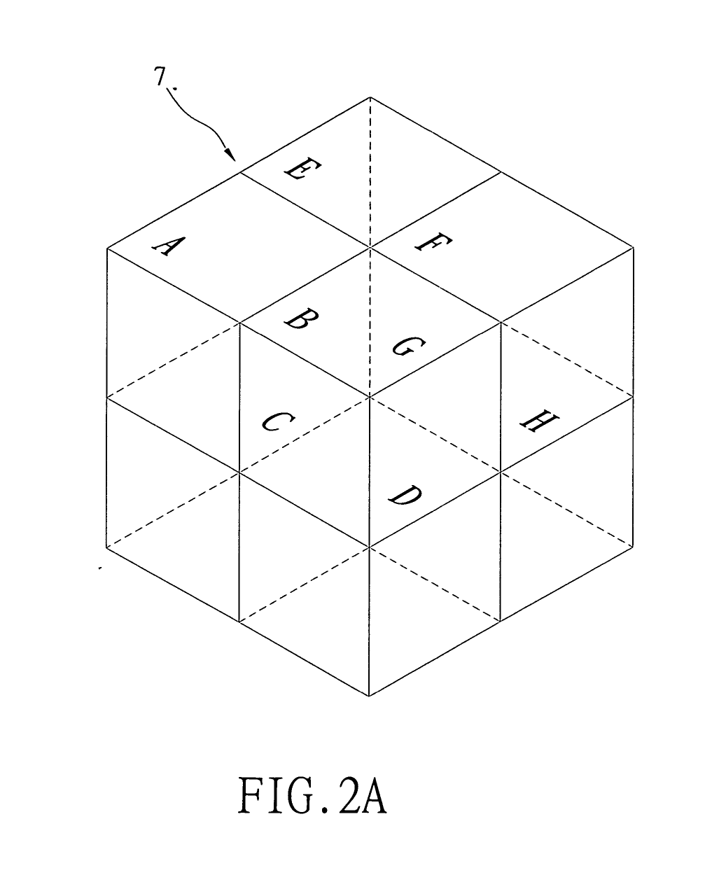

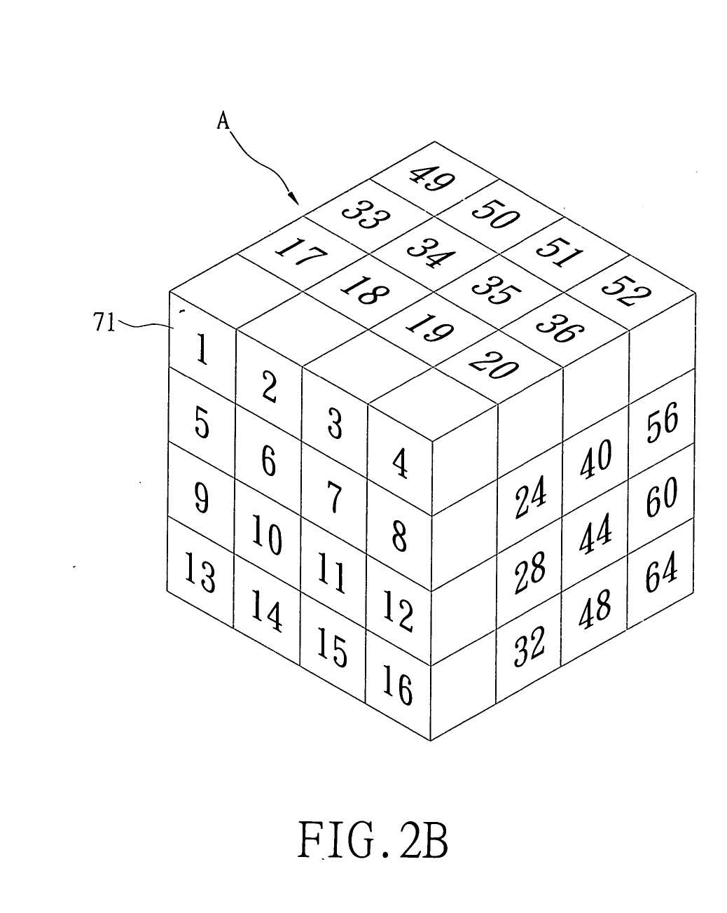

Reference is made to FIG. 2A, which shows a schematic diagram of reconstructing a three-dimensional image via symmetric blocks of the present invention. The illustration is simplified, and the three-dimensional image 7 is composed of a plurality of sub-blocks A˜H that are arranged in order. Each of the sub-blocks is composed of a plurality of volume pixels, such as a sub-block A, which is composed of 4×4×4 volume pixels 71 that are arranged in order, as shown in FIG. 2B. In FIG. 2A, the three-dimensional image 7 is reconstructed by reading the data of the sub-blocks A˜H in order. Each of the volume pixels 71 is reconstructed by reading the data according to its arrangement order.

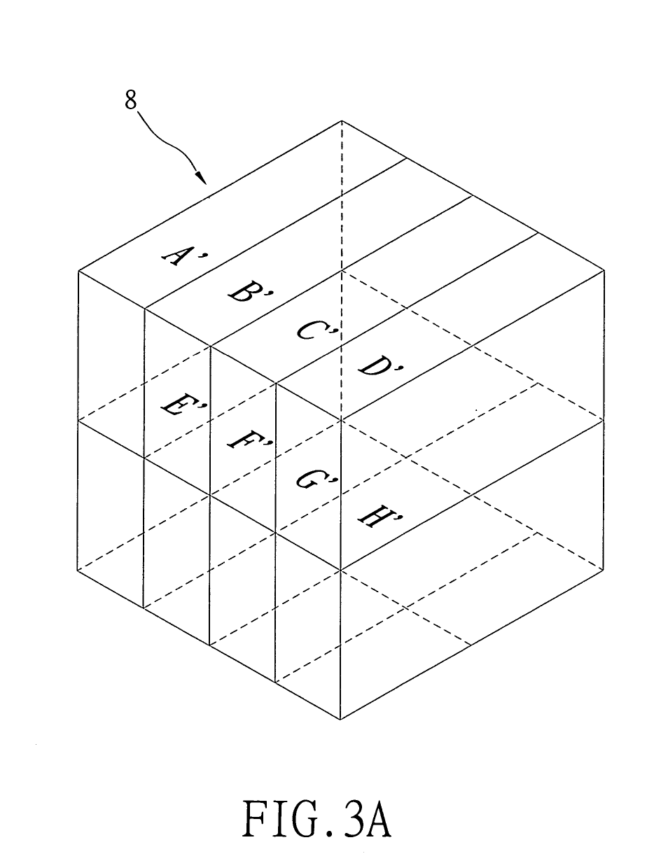

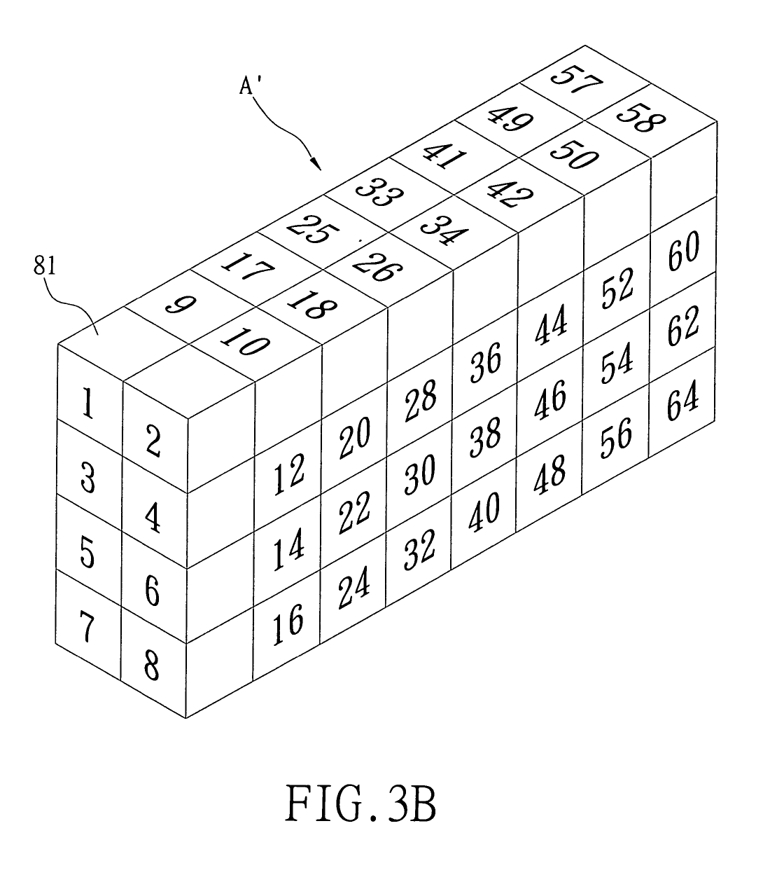

Reference is made to FIG. 3A, which shows a schematic diagram of reconstructing the three-dimensional image via asymmetric blocks of the present invention. The three-dimensional image 8 is composed of a plurality of sub-blocks A′˜H′ that are arranged in order. Each of the sub-blocks is composed of a plurality of volume pixels, such as a sub-block A′, which is composed of 2×4×8 volume pixels 81 that are arranged in order, as shown in FIG. 3B. In FIG. 3A, the three-dimensional image 8 is reconstructed by reading the sub-blocks A′˜H′ in order. Each of the volume pixels 81 is reconstructed by reading the data according to its arrangement order.

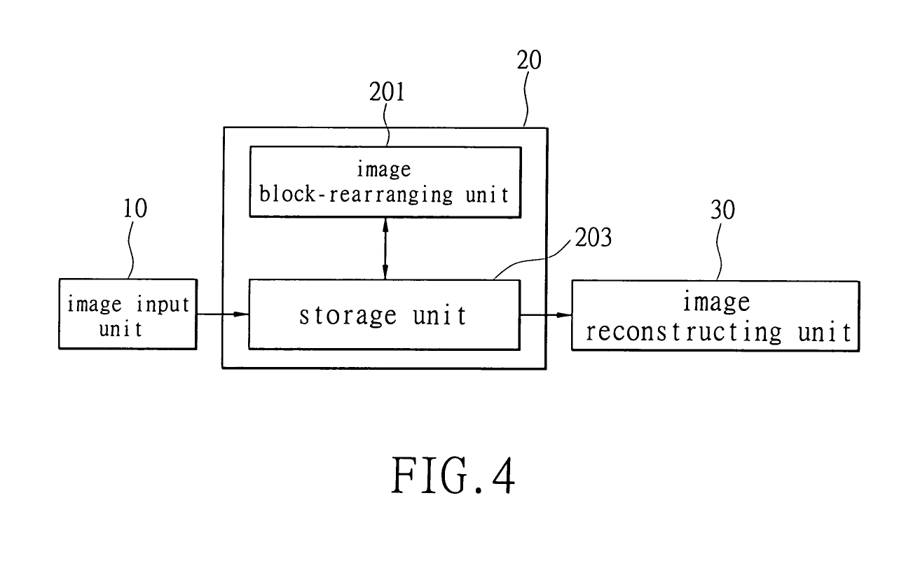

Reference is made to FIG. 4, which shows a block diagram of the preferred embodiment of the present invention. The apparatus for reconstructing multi-dimensional image data obtains a plurality of two-dimensional image data for generating a three-dimensional image of an object via an image input unit 10. Next, an image data-converting unit 20 is used to form a plurality of sub-blocks for the three-dimensional image according to the plurality of two-dimensional image data. An image-reconstructing unit 30 reads the plurality of sub-blocks so as to reconstruct the three-dimensional image of the object via a ray-casting method or a voxel-projection method. The image-reconstructing unit 30 can be a main memory, a cache memory, a display card memory, a hard disk, or an optical disk. The image input unit 10 can be a computed tomography (CT) or a magnetic resonance image (MRI).

The image data-converting unit 20 includes an image block-rearranging unit 201 and a storage unit 203. The image block-rearranging unit 201 is a cache or a memory. The image block-rearranging unit 201 uses the sub-block as a unit to rearrange the plurality of two-dimensional image data. The rearranged sub-blocks are arranged in order to form a full three-dimensional image. The sub-block is composed of a plurality of volume pixels. The sub-blocks each use the volume pixel as a basic unit of length for each dimension. The transparency, brightness, and density of each of sub-blocks are equal. The sub-block is a symmetrical or an asymmetric block.

The storage unit 203 is a cache or a memory. The storage unit 203 is used for storing the plurality of two-dimensional image data for forming the three-dimensional image of the object obtained by the image input unit 10, and the data of the sub-clocks that comes from rearranging the three-dimensional image by the image block-rearranging unit 201. The storage unit 203 is a main memory, a cache memory, a display card memory, a hard disk, or an optical disk.

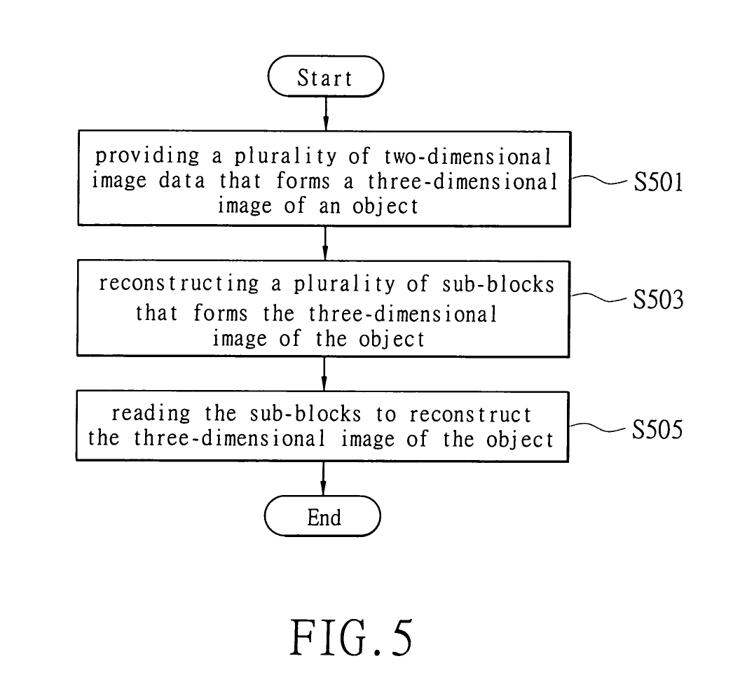

Reference is made to FIG. 5, which shows a flow chart of the preferred embodiment of the present invention. Firstly, a plurality of two-dimensional images for forming a three-dimensional image of an object is provided (S501). The two-dimensional images can be obtained by processing the object via an image input unit, such as a computed tomography (CT) or a magnetic resonance image (MRI). Next, the two-dimensional images are rearranged to form a plurality of sub-blocks (S503). The sub-block is composed of a plurality of volume pixels. The sub-blocks each use the volume pixel as a basic unit of length in each dimension. The sub-block is a symmetrical or an asymmetric block. Finally, reading the sub-blocks in order and the rearrangement order of the volume pixels in the sub-block reconstructs the three-dimensional image of the object (S505).

The present invention has the following characteristics:

1. The present invention uses a sub-block as a unit to rebuild the image data of the object. It is different from the volume rendering method that uses an image plane as a unit. When the present invention is executed in a computer, the hit rate of reading the data from a cache/caches is increased so as to speed up the three-dimensional image reconstruction. As such the present invention is faster and more convenient for users.

2. A sub-block is used as an unit for reconstructing the image data. The sub-block is a symmetrical or an asymmetric block. Therefore, it is more suitable for a variety of three-dimensional image reconstructions and operations.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An apparatus for reconstructing multi-dimensional image data providing a plurality of two-dimensional images for an object to reconstruct a three-dimensional image of the object, comprising:
an image data-converting unit for rearranging a plurality of sub-blocks that forms the said three-dimensional image of the object according to at least one view of the object in multi-dimensions; and
an image-reconstructing unit for reading the sub-blocks of the image data-converting unit to reconstruct the three-dimensional image of the object.

2. The apparatus for reconstructing multi-dimensional image data as claimed in claim 1, wherein the said image data-converting unit comprises:
a storage unit for storing at least one two-dimensional image and the sub-blocks; and
an image block-rearranging unit for reconstructing the sub-blocks according to the at least one two-dimensional image and the sub-blocks in the storage unit to increase the data hit rate of the image-reconstructing unit, wherein each one of the sub-blocks has a basic length in each dimension.

3. The apparatus for reconstructing multi-dimensional image data as claimed in claim 1, wherein the image block-rearranging unit comprises a main memory, a cache, a display card memory, a hard disk, or/and an optical disk.

4. The apparatus for reconstructing multi-dimensional image data as claimed in claim 1, wherein the storage unit comprises a main memory, a cache, a display card memory, a hard disk, or an optical disk.

5. The apparatus for reconstructing multi-dimensional image data as claimed in claim 1, wherein the image-reconstructing unit comprises a main memory, a cache, a display card memory, a hard disk, or an optical disk.

6. The apparatus for reconstructing multi-dimensional image data as claimed in claim 1, wherein the said sub-block comprises at least one volume pixel.

7. The apparatus for reconstructing multi-dimensional image data as claimed in claim 1, wherein the sub-blocks comprise a plurality of symmetric blocks, wherein the symmetric blocks comprise at least one volume pixel, and the length of each dimension of the sub-blocks is of the same.

8. The apparatus for reconstructing multi-dimensional image data as claimed in claim 1, wherein the sub-blocks comprise a plurality of asymmetric blocks, wherein the asymmetric blocks comprise at least one volume pixel, and the length of at least two dimensions of the sub-blocks are unequal.

9. The apparatus for reconstructing multi-dimensional image data as claimed in claim 1, further comprising:
an image input unit for obtaining a plurality of two-dimensional images that form the object.

10. The apparatus for reconstructing multi-dimensional image data as claimed in claim 9, wherein the image input unit comprises a computed tomography, an ultrasound image, and/or a magnetic resonance image.

11. A method for reconstructing multi-dimensional image data is used to build a three-dimensional image of an object and store at least one two-dimensional image that forms the three-dimensional image of the object in a storage unit, comprising;
generating a plurality of sub-blocks for reconstructing the object according to at least one two-dimensional image data, wherein each of the sub-blocks has a basic length in each dimension; and
reading the sub-blocks so as to reconstruct the three-dimensional image of the object.

12. The method for reconstructing multi-dimensional image data as claimed in claim 11, wherein the two-dimensional image comprises a computed tomography, an ultrasound image, and/or a magnetic resonance image.

13. The method for reconstructing multi-dimensional image data as claimed in claim 11, wherein the storage unit comprises—a main memory, a cache, a display card memory, a hard disk, and/or an optical disk.

14. The method for reconstructing multi-dimensional image data as claimed in claim 11, wherein the sub-block comprises at least one volume pixel.

15. The method for reconstructing multi-dimensional image data as claimed in claim 11, wherein the storage unit comprises the sub-blocks.

16. The method for reconstructing multi-dimensional image data as claimed in claim 11, wherein the sub-blocks are symmetric blocks, and the length of each of the dimensions of the sub-blocks are equal.

17. The method for reconstructing multi-dimensional image data as claimed in claim 11, wherein the sub-blocks are asymmetric blocks, and the length of at least two dimensions of the sub-blocks are unequal.

18. The method for reconstructing multi-dimensional image data as claimed in claim 11, wherein the step of reading the sub-blocks to reconstruct the three-dimensional image of the object comprise a ray-casting method and/or a voxel-projection method.
